(19) United States
(12) Patent Application Publication
(10) Pub. No.: US 2013/0254131 A1
(43) Pub. Date: Sep. 26, 2013

(54) GLOBAL RFP/RFQ/TENDER MANAGEMENT

(71) Applicant: Martin Hubert, Huntington Beach, CA (US)

(72) Inventor: Martin Hubert, Huntington Beach, CA (US)

(73) Assignee: FREIGHTGATE, Huntington Beach, CA (US)

(21) Appl. No.: 13/533,214

(22) Filed: Jun. 26, 2012

Related U.S. Application Data
(60) Provisional application No. 61/615,066, filed on Mar. 23, 2012.

(51) Int. Cl. G06Q 10/08

(52) U.S. Cl. 705/330

(57) ABSTRACT

A system and method for automatically managing complex tender inquiries between suppliers and logistics service providers is presented. The system is presented as executable code on an electronic storage medium that receives a shipping tender from a customer, creates several shipping data objects based on the shipping tender in order to receive shipping data from multiple sources, and uses the acquired shipping data to generate a response object in response to the shipping tender to be presented to the customer. The method presented comprises the steps of receiving a shipping tender, analyzing the shipping tender in order to generate several shipment data objects, receiving values corresponding to the shipping attributes of at least some of the shipment data objects, generating a response object as a function of one or more of the shipment data objects and presenting the response object to a user.

This application claims the benefit of priority to U.S. provisional application having Ser. No. 61/615,066 filed on Mar. 23, 2012. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is management of shipping tenders.

### BACKGROUND

The global economy depends, in large part, on the ability of merchants and manufacturers to economically transport goods to distant locations. The transportation of goods across multiple jurisdictions, each jurisdiction having their own local currencies and economies (e.g., shipping rates), creates a significant logistical challenge.

Under current methods for procuring freight rates, a global shipper (e.g., importer, beneficial cargo owner or “BCO”), a third-party logistics provider (“3PL”), a fourth-party logistics provider (“4PL”), or a non-vessel operating common carrier (“NVOCC”) submits a request for a quotation (RFQ), request for proposal (RFP), or some form of tender (e.g., set of requests) to a logistics service provider (e.g., a NVOCC, a vessel operating common carrier or “VOCC”, a 3PL, a freight forwarder, an airline, a trucker, a warehouse operator, etc.). The logistics service provider then prepares and returns an answer (e.g., cost estimate) to the requestor.

Tenders often contain a cover letter explaining certain special requirements such as deadlines, clarification call dates and procedures, desired rate validity ranges, etc., a list of origin and destination points, equipment sizes or weights and cargo volumes. Occasionally routing and transit time requirements and shipping volumes are included as well. This information is mostly organized in spreadsheets. For a requestor, this has the advantage that all responses are returned in a uniform fashion making the comparison and analysis easier. These spreadsheets can consist of hundreds if not thousands of rows that need to be completed with information from many different data sources. Currently, the freight industry relies on manual data entry methods (e.g., cut-and-paste) to populate these spreadsheets. This approach is very time consuming and is also prone to human error.

It would be advantageous to replace current manual data entry methods with an automated solution. Efforts have been made to automate other data manipulation tasks in the shipping industry. For example, U.S. patent application 2007/0067146 to Devarajan titled “System and Method of Interactively Optimizing Shipping Density for a Container,” filed Sep. 16, 2005, discusses an automated system and method for a user to optimize shipping densities for component parts being transported in shipping containers. The Devarajan patent does not discuss optimization of the rates on shipping a container from one location to another. Unfortunately, the logistical complexity of current freight procurement and the various spreadsheet formats used among different parties presents far more challenging obstacles to automation than shipping density optimization and require a more complex and dynamic solution.

For example, in the management of freight RFPs, RFQs, and tenders, many spreadsheets are protected, allowing only unlocked data cells to be written. In these cases, a manual process will need to do even more cutting and pasting as an intermediary spreadsheet will need to be created for internal use and then the resulting data needs to be pasted back into the original file. Another challenge is the fact that data is gathered from many different sources and the quality/precision of data can vary drastically from one source to the next.

Another challenge is keeping track of numerous jurisdictional laws, requirements, fees, surcharges, and specific requirements. From the point of view of the logistical service, requests are received from requestors (e.g., supplier of goods, recipient of goods) located in different jurisdictions and each supplier expects an answer to the request in a different format suitable for their jurisdictional requirements.

The multi-jurisdictional element is further exasperated by the fact that the transportation industry is a very dynamic market environment—price rates and transportation choices are constantly changing.

It would be advantageous to provide a system and method for addressing the challenges and deficiencies mentioned above. A distributed approach for sourcing the different data elements is needed for a holistic solution to the problems associated with the current global tender management GTM systems and methods. Allowing multi-dimensional constraints in combination with the ability for multiple incremental iterations and data element level status coding enables the process of incremental data completion. As the data sources can be heterogeneous in nature, a system should allow for loose coupling to minimize system interdependencies. A possible implementation will utilize a combination of direct database calls and web service calls, it even can use prior tenders or rate templates uploaded into the system as an implicit data source.

Thus, there is still a need for improved systems and methods for managing shipping requests.

### SUMMARY OF THE INVENTION

The inventive subject matter provides apparatus, systems and methods to automatically manage complex shipping tender inquiries between global suppliers and logistics service providers.

One possible embodiment of the inventive subject matter is a shipping tender management system comprising an import engine, a request engine, a freight analysis engine and a tender management interface. The import engine can be configured to receive a shipping tender object (RFQ, RFP, etc.). The request engine can be configured to analyze the shipping tender object in order to generate several shipment data objects, each shipment data object comprising a specific attribute of the shipping tender. The freight analysis engine can be configured (i) to receive values, corresponding to shipment attributes of at least some of the shipment data objects, and (ii) to generate a response object as a function of a subset of the several shipment data objects. The tender management interface can be configured to present the response object to the user.

Alternatively, in another possible embodiment of the inventive subject matter, a method of managing shipping tenders is contemplated. In some embodiments, the method can receive, using an import engine, a shipping tender object. The method can analyze, using a request engine, the received shipping tender object in order to generate several shipment data objects, each shipment data object comprising a shipment attribute. The method can receive, using a freight analysis engine, values corresponding to shipment attributes of at least some of the shipment data objects. Another step involves generating, using the freight analysis engine, a response object as a function of one or more of the shipment data objects. Additionally, the method can present, using a tender management interface, the response object to the user.

In both the system and method embodiments described above, the import engine, request engine and freight analysis engine can be further configured in a number of ways.

In some embodiments, the request engine is configured to analyze the shipping tender object as a function of a mapping algorithm. In some of these embodiments, the mapping algorithm comprises at least one condition. The request engine of some embodiments is further configured to depivotize data in the shipping tender object and to generate depivotized request objects.

As mentioned, the freight analysis engine of some embodiments is configured to receive values that correspond to shipment attributes of at least some of the shipment data objects. In some of these embodiments, the freight analysis engine is further configured to receive the values from at least one of several possible sources such as vendors, databases of previously stored request objects, published data, and privately accessible data. Furthermore, the freight analysis engine of some embodiments is further configured to generate a confidence value associated with each shipment data object based on the credibility of the source from which the object's values were derived. After generating the response object, the freight analysis engine of some embodiments is further configured to store the response object in a past response server as a stored response object.

In some embodiments, the freight analysis engine is also configured to generate response objects iteratively. That is, the freight analysis engine is configured to iteratively receive new values corresponding to shipment attributes of at least some of the data objects and generate a new response object as a function of one or more of the shipment data objects. The new response object is then compared to a previous response object and a trend analysis is generated based on the comparison. In other embodiments, the freight analysis engine is also configured to compare the response object to a third party pricing object and generate a report comprising a result from the comparison.

Additionally, the shipment attributes stored in each shipment data object could comprise at least one of a freight charge, a fuel surcharge, a custom clearance charge, a Bunker surcharge, a currency adjustment factor, a local tax, a tariff, a currency, and an exchange rate.

Some embodiments of the shipping tender management system also include an export engine. In some of these embodiments, the export engine is configured to export the response object in a format requested by the user. In alternative embodiments, where the shipping tender object is received in a first format, the export engine is configured to export the response object in the same first format.

Other contemplated embodiments include an error management engine. The error management engine is configured to identify an error in at least one of the shipping tender objects or shipment data objects. Furthermore, in some embodiments, the error management engine configures an error management interface to present the identified error to a user.

Various objects, features, aspects and advantages of the inventive subject matter will become more apparent from the following detailed description of preferred embodiments, along with the accompanying drawings in which like numerals represent like components.

### BRIEF DESCRIPTION OF THE DRAWING

FIG. 1 is a general schematic of a shipping tender management system.

FIG. 2 is an example of a shipping tender and an associated shipping tender object, shipping data objects and a response object.

FIG. 3 illustrates a process for managing shipping tenders.

FIG. 4 is an example of a typical manual tender process.

FIG. 5 is an example of one embodiment of an automated tendering process.

### DETAILED DESCRIPTION

The inventive subject matter provides apparatus, systems and methods that receive a shipping tender (e.g. Request for a quotation RFQ, Request for Proposal RFP, etc.) from a customer (e.g., global supplier, importer, BCO, etc.), automatically create several shipping data objects based on the shipping tender in order to receive shipping data from multiple sources, and generate a response object in response to the shipping tender.

The discussion herein provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

Throughout the discussion herein, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions. One should appreciate that the inventive subject matter described herein provides numerous technical effects, systems and methods for facilitating management of shipping requests.

Additionally, throughout the discussion herein, numerous references are made to shipping requests, shipping tenders and shipping tender objects. A shipping request is a request made by a customer to a logistics provider for the single shipment of a certain volume, weight, quantity etc. from an origin location to a destination location. For example, a single shipment of 100 boxes from Los Angeles to Hong Kong. A shipping tender consists of a plurality of shipping requests representing multiple shipping transactions. The set of shipping requests in a shipping tender can vary broadly by type of cargo being shipped, origin and destination, date and time of shipment, quantity, etc. For example, a shipping tender can consist of many different individual shipping requests for various toy products being shipped from Hong Kong to destinations throughout the world, in various quantities, on various days throughout a given year. A shipping tender object is an object that stores data describing a shipping tender.

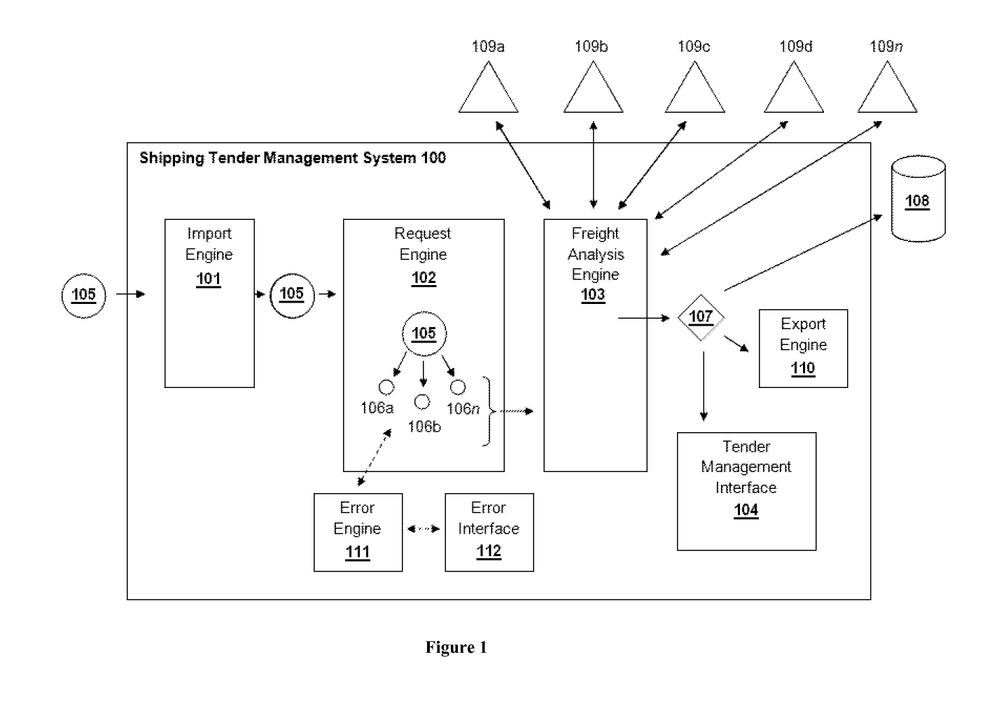

In FIG. 1 illustrates a shipment tender management system 100 that includes an import engine 101, request engine 102, a freight analysis engine 103, and a tender management interface 104. The operations of the import engine 101, request engine 102, freight analysis engine 103 and tender management interface 104 and other components of the shipment tender management system 100 will be described in further detail below. In some embodiments, the shipping tender management system 100 and related components are implemented as executable programming code that are stored on a tangible electronic storage medium (e.g., a disc, flash drive, memory, etc.).

The import engine 101 is configured to receive a shipping tender object 105. The shipping tender object 105 is created based on a specified shipping tender provided by the user or some other source. The shipping tender can be in one of many standard data storing formats such as a spreadsheet, text file, database file, etc. The shipping tender object 105 stores many attributes and values, at least some of which are derived from the shipping tender. The shipping tender object 105 also has at least some attributes and values that are left empty, to be filled by the shipping tender management system 100.

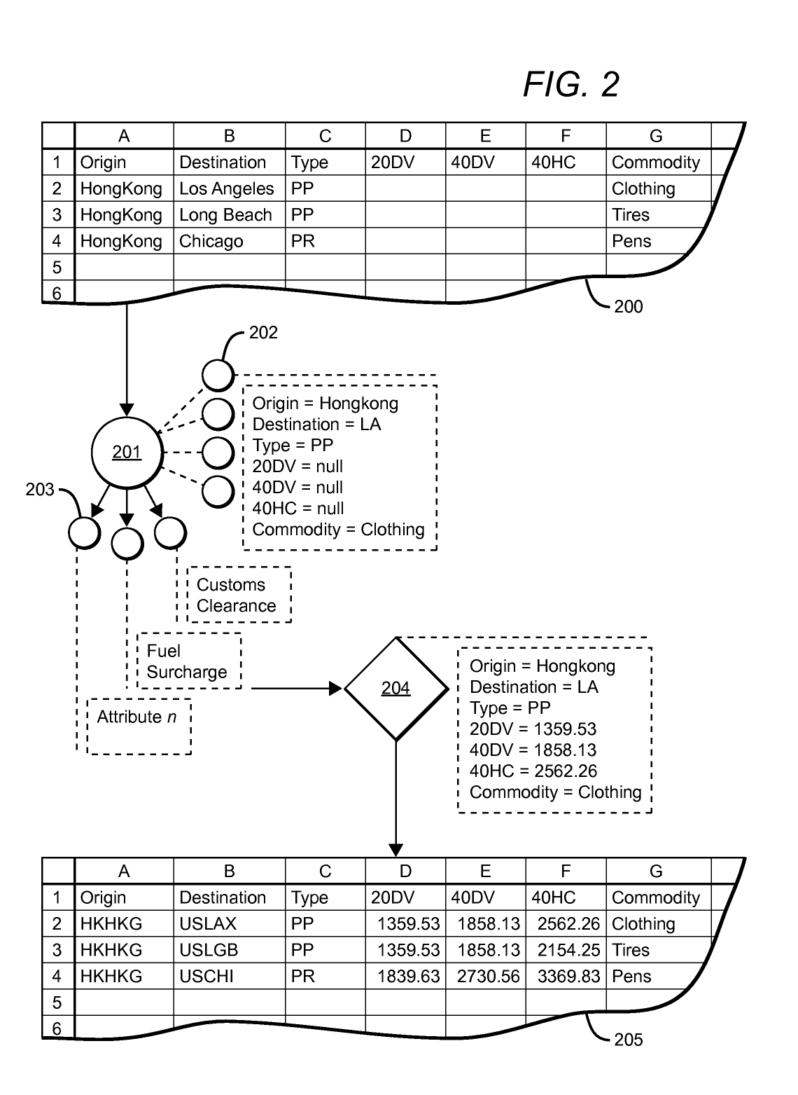

For example, in FIG. 2, a shipping tender object 201 is created from a shipping tender 200. Here, the shipping tender 200 consists of data from three separate shipping requests represented by transactions originating in Hong Kong with destinations in Los Angeles, Long Beach and Chicago, respectively. The shipping tender object 201 stores the attributes and values of the shipping tender 200 including empty values for three shipping attributes, 20DV, 40DV and 40HC shown. Values for these attributes are initially unknown to the user or the system. In some embodiments, the shipping tender object can further comprise a plurality of request objects storing the attributes of each shipping request individually. This is illustrated, by example in FIG. 2 with shipping request objects 202.

Referring back to FIG. 1, the request engine 102 is configured to analyze the shipping tender object 105 in order to generate several shipment data objects 106. Each shipment data object 106 comprises a specific attribute of the shipment tender object 105. An example is shown in FIG. 2, where shipment data objects 203 are generated from analyzing shipping tender object 201. Each shipment data object comprises a relevant shipping attribute for which the system must fill a value, for example, carrier charges, customs clearance fees, harbor fees, port taxes, etc.

The request engine 102 has the ability to apply to the shipping tender object 105 (or data in the shipping tender object 105) mapping technologies that allow the user (e.g. the data receipt, data base manager, logistics service) to define which attribute from the shipping tender object 105 is associated which shipment data object 106.

In some embodiments, the request engine 102 also has the ability to define units of measure (“UOM”) and convert between different UOMs (e.g., a request that lists price rates in Euros can be converted to dollars). The request engine includes mapping algorithms that are designed to account for different data organization (e.g., it can import shipping tender objects from many different formats, including proprietary formats).

The request engine 102 of some embodiments is also capable of de-pivotizing a set of shipping tender data. The de-pivotizing function, when applied to a shipping tender object 105, allows data that is laid out horizontally in rows to be reoriented vertically into columns for instances when the data could be managed better in a vertical orientation or vice versa. As an example, repeated, daily observations of a currency exchange rate may be presented in the shipping tender object 105 horizontally, in a row, each column associated with a single date. Such orientation may not be useful for time series analysis of the exchange rates; therefore, in some embodiments of the inventive subject matter, the request engine 102 can reorient the data, and add or remove columns or rows as needed, in order to allow for a time series analysis. In some embodiments, the request engine 102 is also capable of re-pivotizing a matrix and returning the shipping tender object data to its original orientation.

Alternatively, in some embodiments, the import engine and request engine can be the same. That is, all the functions performed by the import engine and the request engine as described above could be handled by a single engine in the shipping tender management system 100.

The software's freight analysis engine 103 is configured to generate a response object 107 by gathering numerous data values (price rates, dates price rates were published, currency, currency exchange rates, and jurisdictional laws) from several sources 109n based on the shipping data objects 106 generated by the request engine. The data gathered by the freight analysis engine 103 is used to fill unknown values or update existing values of attributes in the shipping tender object 105 in order to generate a response object 107. In the example provided by FIG. 2, the response object 204 is generated by the system based on the shipping data objects 203, with empty values for 20DV, 40DV and 40HC shipping attributes now filled with data gathered by the freight analysis engine.

Particularly, the freight analysis engine is configured to gather the data from numerous data sources of varying quality 109a, 109b, 109c, 109d . . . 109n and assign a confidence level to the data. In some embodiments, the freight analysis engine receives the data by configuring an interface that presents the shipping tender object or shipment data object attributes to a logistics provider or third party in a manner that allows the party to manually provide data values to the freight analysis engine. In alternative embodiments, the freight analysis engine receives data directly from a data source.

Confidence levels can be assigned based on any number of relevant factors. For example, data from previously accepted tenders may be assigned a high confidence value, data from non-accepted tenders may be assigned a medium confidence value, and data from rejected tenders may receive a low confidence value. Confidence levels may also be assigned based on the date a previous tender was accepted, the requestor that accepted, and a number of requestors that accepted the response data (e.g., price, term, etc.). Confidence levels may also be generated as a function of the credibility of a source from which the value of the shipment object is received.

The freight analysis engine 103 is additionally capable of populating a response object 107 using iterations. For example, a first iteration can comprise populating the response object 107 using only data from previously accepted tenders. A second iteration can comprise populating the remaining fields in the response object 107 using data from non-accepted tenders.

The freight analysis engine 103 is further configured to auto fill a response form and display or deliver the response to the requestor. The shipping tender management system 100 is preferably coupled to a network via an electronic communication channel (e.g., WAN, LAN, internet) and is accessible by other systems. In some embodiments the shipping tender management system 100 are accessible via a web portal. In such embodiments the requestor can submit a request to a logistics service via the web portal. The logistics service can either directly or indirectly manage the storage medium and shipping tender management system 100 in order to generate a response.

In some embodiments, the freight analysis engine 103 is further configured to store the response object 107 in a past response server 108 as a stored response object. In some embodiments, it is configured to receive values corresponding to the shipment attributes from one or more of a set of vendors 109, databases of previously stored request objects 110, published data 111, privately accessible data 112 or other external value sources.

The freight analysis engine 103 is in other embodiments configured to generate a trend analysis based on the comparison of a new response object to an older response object. In still other embodiments, the tender management interface 104 is further configured to present the trend analysis to the user.

In some embodiments, the freight analysis engine 103 is also configured to compare the response object to a third party pricing object 109n and generate a report comprising a result from the comparison.

In addition, in some embodiments, the system described above further comprises an export engine 115. The export engine 115 is configured to export the response object 107 generated by the freight analysis engine 103 to a format requested by the user. Additionally, in instances in which the shipping tender object 105 is received in a first format, the export engine 115 is configured to export the response object 107 in the same first format. In the example provided by FIG. 2, the response object 204 is exported as a spreadsheet 205 to be presented to the user. The exported spreadsheet 205 provides completed data for the previously unknown 20DV, 40DV and 40HC values.

The export engine described above advantageously allows a recipient to receive data in its preferred format while simultaneously allowing the logistics provider to reorganize and/or reformat the data in a proprietary or preferred format.

In yet other aspects, the shipping tender management system is configured to manage data related to transportation services. Transportation service breaks down into many components, such as pickup, consolidation, feeder service, long-haul, deconsolidation, delivery, etc. Each of these components can have additional fees associated with it, also known as surcharges (e.g., fuel surcharges (FSC), peak season surcharge (PSS), alameda corridor surcharge). The charges can even be incurred in different currencies and potentially even different units of measure (“UOM”). Each charge can potentially have different validity date ranges (e.g., a PSS is only applicable from October to December). A requestor however may desire different breakdowns of the charges (typically less detailed) and in predetermined target currencies. As such, a system that supports multiple currencies will be more valuable in a global market. In order to support combining of charges in the way defined by the requestor a system needs to provide means to do so, this is in essence a reverse mapping process. In a manual environment people would use spreadsheet formulas and lookup functions in combination with filtering. As one can imagine, when used on big files, this is very time consuming and creates tremendous amounts of error possibilities, not to mention that it requires individuals with both deep spreadsheet expertise and industry knowledge.

As freight companies make their money by the margins between buying price and selling price or by collecting management fees, the system needs to provide means to manage both buy and sell aspects of pricing. It may offer yield analysis, as well as, if shipment profiles are available, time phased profitability projections.

Another common problem with many previous systems is failure to provide proactive yield management. In many cases, prospects or existing customers have rate data contained in spreadsheets which, more often than not, are formatted and organized in many different ways. Faced with a very dynamic market environment where prices and transportation choices change constantly, a proactive transportation provider, carrier or consultant will need to evaluate the rate data on a frequent basis. Manually entering and assembling the many rate components for a sizable number of customers is extremely labor intensive. Thus, in some embodiments of the inventive subject matter, the request engine 102 has the ability to save mapping files for repeated use in order to enable efficient analysis and proactive rate management. Further automation such as associating mapping files with the respective data file will allow setting up file drops or email drops or similar mechanisms to receive subsequent files and return the analysis to the respective user or user group in a similar fashion such as through an email, file drop, online hyperlink, etc.

Since capacity is a constraint for any given carrier, some embodiments of the system are configured to look up rates for multiple transportation options (e.g., carriers, routings etc.). Some embodiments also provide exception management (e.g. origin/destination pair combinations where no rate was found). For example, in such embodiments, the system allows the user to find and provide rates for inland transportation when only an ocean rate is found, or an ocean rate when only an inland rate is found

In still other embodiments, the shipping tender management system allows for export of the data in analysis spreadsheets to enable a structured review in predetermined formats. The format can contain data elements that ensure any data element changed in the spreadsheet can be re-imported into the system, allowing an offline/online collaboration. The system also allows a user to discuss and determine appropriate locking mechanisms (optimistic locking/pessimistic locking) to address data versioning issues.

It is further desirable that the system can handle all other accompanying documentation so it should provide a facility to attach cover letters, soft copies, etc. to shipping tender objects or the exported response objects.

In some embodiments, the system also could include an error management engine 116. This engine is configured to identify an error in at least one of the shipping tender objects and the shipment data objects and configure an error management interface 117 to present the identified error to the user.

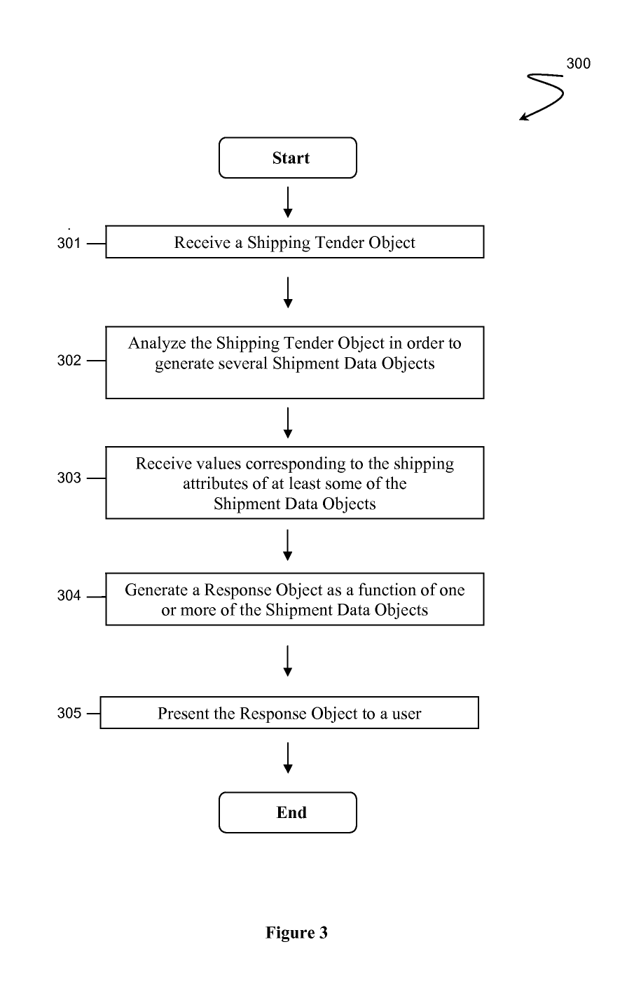

FIG. 3 illustrates a process embodiment of the inventive subject matter. The process shown comprises the steps of receiving (at step 301) the shipping tender object, analyzing (at step 302) the shipping tender object in order to generate several shipment data objects, receiving (at step 303) values corresponding to the shipping attributes of at least some of the shipment data objects, generating (at step 304) a response object as a function of one or more of the shipment data objects and presenting (at step 305) the response object to a user.

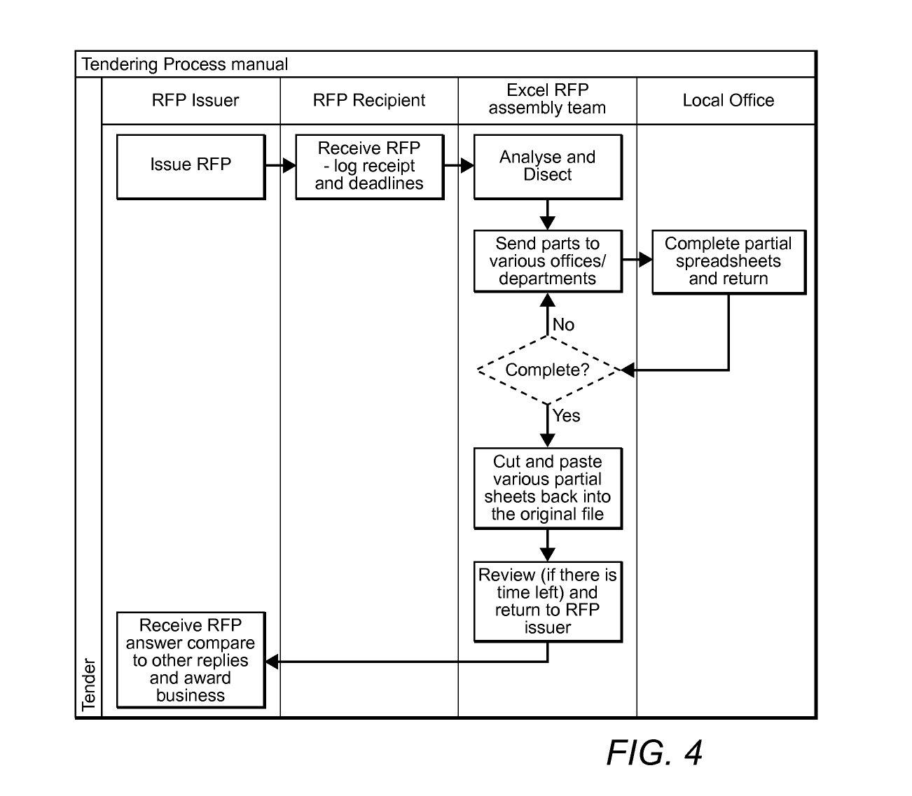

FIG. 4 shows a typical manual tender process. In FIG. 3, the RFP issuer (e.g., requestor) issues a RFP (i.e., the “request”) to the recipient (e.g., logistical service provider) who logs the receipt and creates deadlines. The Recipient sends the request to an assembly team (either internally or externally to the recipient) who analyzes and dissects the request and sends parts to various offices and departments. A local office completes the partial spreadsheets and returns it to the assembly team. If the spreadsheet is complete, the team cuts and pastes the various partial sheets back into the original file as an “answer” (e.g., response) to the request. The team then reviews the response and sends it to the RFP issuer.

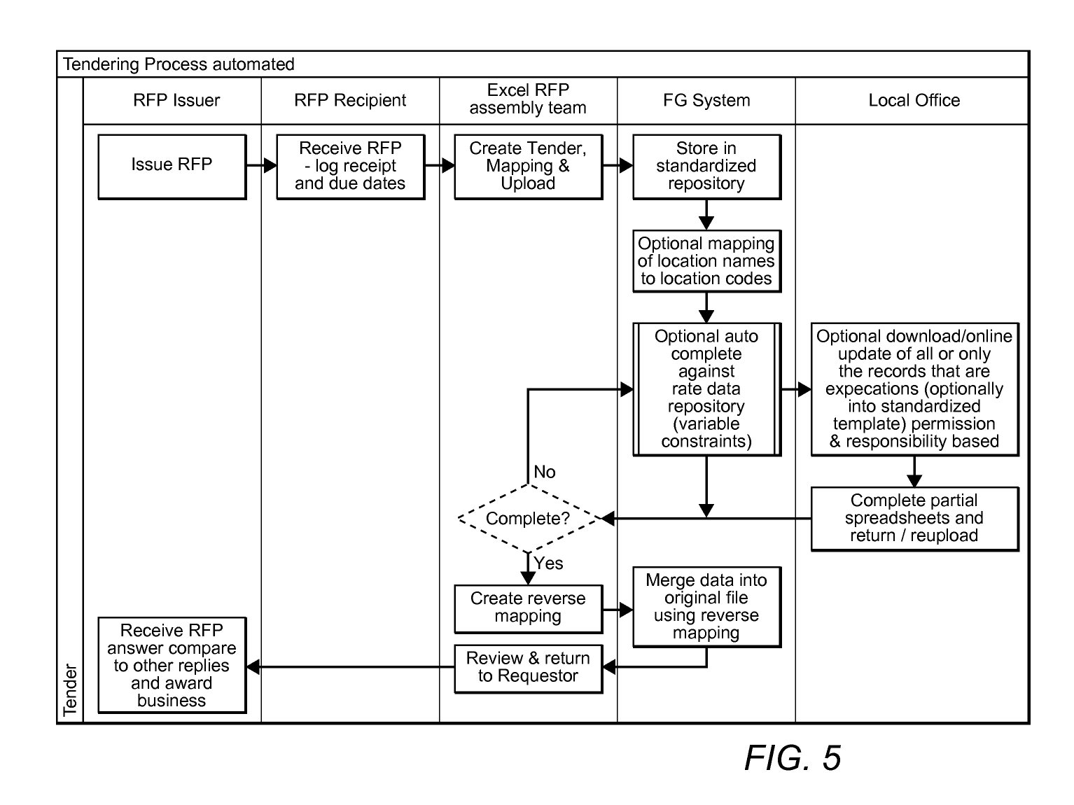

FIG. 5 shows one example embodiment of an automated tendering process. The RFP issuer sends a request to the RFP recipient. The recipient's assembly team then creates a tender and uploads the tender to the system's standardized repository (e.g., an electronic storage medium for storing data in a standard format). The system includes a processor and executable code (e.g., software) configured to map the data from the tender. The software is also configured to auto-complete the tender against a rate data repository that has variable constraints. In other words, the system is configured to automatically generate an answer or response to the original request using rates and other relevant data from numerous data sources. The data used to generate the response may have confidence levels assigned to them. The system is capable of generating the response via an iterative process, using high confidence level data first. The response is downloaded to a local office in either a proprietary format or a standard format. The local office can manage the response and related records via permissions and responsibilities. The local office completes a partial spreadsheet and returns to the team. If the spreadsheet is sufficiently complete, the team can create a reverse mapping and merge the data into the original file. The response is then sent to the requestor.

Those of skill in the art will appreciate that the inventive concepts discussed herein can be applied to logistical scenarios outside of the shipping industry. For example, the systems described herein may be useful for managing construction bids.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

1. A shipping tender management system comprising a computing device having a processor configured to execute software instructions that implement the following steps:
receive a request for rate information that could be used To estimate potential future shipping charges between multiple different origins and destinations, for multiple different commodities, and with respect to multiple other different shipping attributes;
at least semi-automatically obtain the rate information;
generate a response object that includes the rate information; and
present the response object to a user.

2. The shipping tender management system of claim 1, wherein the processor is further configured to receive the request as a table containing columns or rows for The origins, destinations, commodities, and other shipping attributes.

3. The shipping tender management system of claim 1, wherein the response object is renderable as a table.

4. The shipping tender management system of claim 1, wherein the processor is further configured to store the response object in a past response server as a stored response object.

5. The shipping tender management system of claim 3, wherein the processor is further configured to derive data values for at least some of the cells of the table from at least one of a set of vendors, database of previously stored request objects, published data, and privately accessible data.

6. The shipping tender management system of claim 5, wherein the processor is further configured to associate at least some of the data values with confidence values based on a credibility of a source from which the data values were derived.

7. The shipping tender management system of claim 1, wherein the multiple other different shipping attributes include customs clearance fees, harbor fees, and port taxes.

8. The shipping tender management system of claim 1, wherein the processor is further configured to analyze the request as a function of a mapping algorithm.

9. The shipping tender management system of claim 8, wherein the processor is further configured to use the mapping algorithm to associate different ones of the different shipping attributes with different shipment data objects.

10. The shipping tender management system of claim 1, wherein the request is formatted as a shipping tender object and the processor is further configured to depivotize data in the shipping tender object.

11. The shipping tender management system of claim 3, wherein the processor is further configured to iteratively (i) derive new data values for the data values, and and (ii) generate a new response object that include the new data values.

12. The shipping tender management system of claim 11, wherein the processor is further configured to (i) compare the new response object to the response object and (ii) generate a trend analysis based on the comparison.

13. The shipping tender management system of claim 1, wherein the multiple other different shipment attributes include at least one of a fuel surcharge, a Bunker surcharge, a currency adjustment factor, a local tax, a tariff, a currency, and an exchange rate.

14. The shipping tender management system of claim 1, wherein the processor is further configured to (i) identify an error in at least one of the shipping tender object and the shipment data objects, and (ii) configure an error management interface to present the identified error to a user.

15. The shipping tender management system of claim 1, wherein the processor is further configured to compare the response object to a third party pricing object, and generate a report comprising a result from the comparison.

16. A shipping tender management method comprising a computing device having a processor configured to execute the steps of:
receiving a shipping tender object that seeks a matrix of potential future shipping charges between multiple different origins and destinations, for multiple different commodities, and with respect to multiple other different shipping attributes;
analyzing the shipping tender object to generate a plurality of shipment data objects, each shipment data object comprising a shipment attribute;
receiving values corresponding to shipment attributes of at least some of the shipment data objects;
generating a response object as a function of a subset of the plurality of shipment data objects; and
presenting, using a tender management interface, the response object to a user.

17. The shipping tender management method of claim 16, wherein the request object is received in a first format, and the step of presenting comprises exporting the response object in the first format.

18. The shipping tender management method of claim 16, wherein the step of receiving values further comprises receiving the values corresponding to the shipment attributes from at least one of a set of vendors and a database of previously stored request objects.

19. The shipping tender management method of claim 16, wherein each shipment data object further comprises a confidence value based on credibility of a source from which the shipment data object's values were derived.

20. The shipping tender management method of claim 19, further comprising generating the confidence value for each shipment data object as a function of a credibility of a source from which the value of the shipment data object is received.
